(19) United States
(12) Patent Application Publication
(10) Pub. No.: US 2026/0039649 A1
(43) Pub. Date: Feb. 5, 2026

(54) Delayed On-Behalf-Of Authorization Scheme

(71) Applicant: Oracle International Corporation, Redwood Shores, CA (US)

(72) Inventors: Girish Nagaraja, Sammamish, WA (US); Thomas James Andrews, Seattle, WA (US); Ayman Elmenshawy, Seattle, WA (US); Jeffrey Ford, Redmond, WA (US); Matthew Rushton, Portsmouth, NH (US); Hayk Ghazaryan, Bellevue, WA (US)

(73) Assignee: Oracle International Corporation, Redwood Shores, CA (US)

(21) Appl. No.: 18/793,367

(22) Filed: Aug. 2, 2024

(51) Int. Cl. H04L 9/40

(52) U.S. Cl. CPC H04L 63/083

(57) ABSTRACT

Techniques for facilitating a connection between a governing tenancy and a subject tenancy are disclosed. A configuration request is received by an intermediary from a service that is associated with a governing tenancy. The configuration request is a request to configure a feature associated with a subject tenancy. The intermediary determines if any active tenancy link has been established between the governing tenancy and the subject tenancy. In response to confirming that an active tenancy link has been established between the governing tenancy and the subject tenancy, the intermediary a) issues a resource principal token that forms a basis for authorization for the first service within the governing tenancy to initiate actions, associated with the feature, within the subject tenancy and b) responds to the configuration request with the resource principal token.

### TECHNICAL FIELD

The present disclosure relates to systems and methods for use by tenants of a cloud infrastructure environment in accessing software products, services, or other offerings associated with the environment. In particular, the present disclosure relates to Identity and Access Management (IAM) policies.

### BACKGROUND

A cloud computing environment can be used to provide access to a range of complementary cloud-based components, such as software applications or services, that enable organizations or enterprise customers to operate their applications and services in a highly available hosted environment.

The benefits to an organization in moving their application and service needs to a cloud environment include a reduction in the cost and complexity of designing, building, operating, and maintaining their own on-premise data center, software application framework, or other information technology infrastructure. Access to resources in a cloud environment may be restricted using a variety of mechanisms.

Although access may be restricted, cloud computing environments may be configured to allow access to a service provider to perform maintenance or updates on behalf of the customer. The provider should be authorized to access specific data and functionalities without compromising the security of other tenants' data. A cross-tenancy access situation suggests a need for precise control mechanisms to ensure that the provider has the permissions necessary to perform the task while accounting for security vulnerabilities.

Several factors influence the design and implementation of cross-tenancy operations. These factors include the architectural design of the system, the security requirements of each tenant, the legal and regulatory frameworks governing data access and privacy, and the technical capabilities of the authorization mechanisms employed. The interaction between these factors determines the feasibility and security efficacy of cross-tenancy operations, making it necessary to tailor solutions to the specific contexts of the tenants involved.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for providing a cloud infrastructure environment in accordance with an embodiment.

FIG. 2 further illustrates how a cloud infrastructure environment can be used to provide cloud-based applications or services or services in accordance with an embodiment.

FIG. 3 illustrates an example cloud infrastructure architecture in accordance with an embodiment.

FIG. 4 illustrates another example of a cloud infrastructure architecture in accordance with an embodiment.

FIG. 5 illustrates another example of a cloud infrastructure architecture in accordance with an embodiment.

FIG. 6 illustrates another example of a cloud infrastructure architecture in accordance with an embodiment.

FIG. 7 illustrates how the system can provide dedicated or private label cloud environments for use by tenants or customers of a cloud infrastructure environment in accordance with an embodiment.

FIG. 8 further illustrates the use of private label cloud realms for use by tenants or customers of a cloud infrastructure environment in accordance with an embodiment.

FIG. 9 further illustrates the use of private label cloud realms for use by tenants or customers of a cloud infrastructure environment in accordance with an embodiment.

FIG. 10 illustrates a system for providing access to software products or services in a cloud computing or other computing environment in accordance with an embodiment.

FIG. 11 illustrates a tenancy link system architecture in accordance with one or more embodiments.

FIG. 12 illustrates an example set of operations for controlling governing tenancy access to subject tenancy resources in accordance with one or more embodiments; and

FIG. 13 illustrates an example set of operations for controlling governing tenancy access to subject tenancy resources in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD ENVIRONMENTS
3. TENANCY LINK SYSTEM ARCHITECTURE
4. CONTROLLING GOVERNING TENANCY ACCESS TO SUBJECT TENANCY RESOURCES
5. EXAMPLE EMBODIMENT
6. MISCELLANEOUS; EXTENSIONS

### 1. General Overview

One or more embodiments enable a service, associated with a governing tenancy, to configure a feature associated with a subject tenancy in response to confirming an active tenancy link between the governing tenancy and the subject tenancy. Enabling the service includes issuing credentials that form the basis for authorization of the service to configure the feature associated with the subject tenancy.

The system receives a configuration request from a service that is associated with a governing tenancy. The configuration request is a request to configure a feature associated with a subject tenancy. The system determines if any active tenancy link has been established between the governing tenancy and the subject tenancy. The system then confirms that an active tenancy link (that was established prior to the receipt of the configuration request) has been established between the governing tenancy and the subject tenancy. In response to confirming that an active tenancy link has been established between the governing tenancy and the subject tenancy, the system issues a resource principal token that forms a basis for authorization for the first service within the governing tenancy to initiate actions, associated with the feature, within the subject tenancy. The system responds to the configuration request with the resource principal token.

One or more embodiments described in this Specification and/or recited in the claims may not be included in this General Overview section.

### 2. Cloud Environments

One or more embodiments provide features associated with dedicated or private label cloud (PLC) environments for use by tenants of a cloud infrastructure environment in accessing software products, services, or other offerings associated with the environment.

A cloud computing or cloud infrastructure environment can be used to provide access to a range of complementary cloud-based components, such as software applications or services, that enable organizations or enterprise customers to operate their applications and services in a highly available hosted environment.

The benefits to an organization in moving their application and service needs to a cloud infrastructure environment include a reduction in the cost and complexity of designing, building, operating, and maintaining their own on-premise data center, software application framework, or other information technology infrastructure.

### Cloud Infrastructure Environments

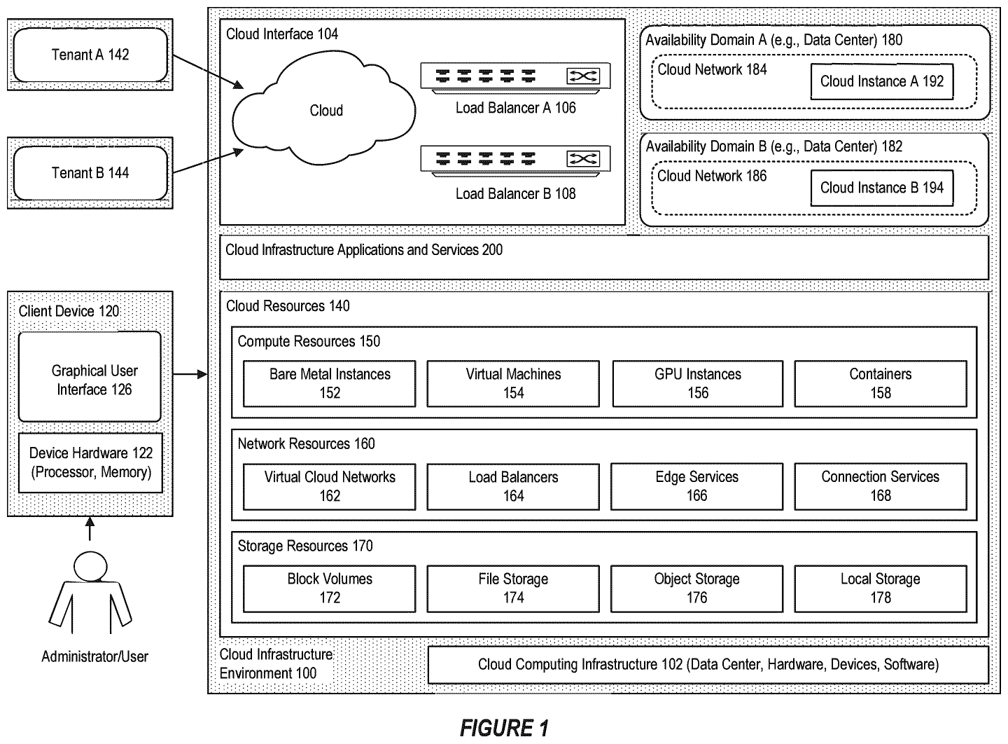

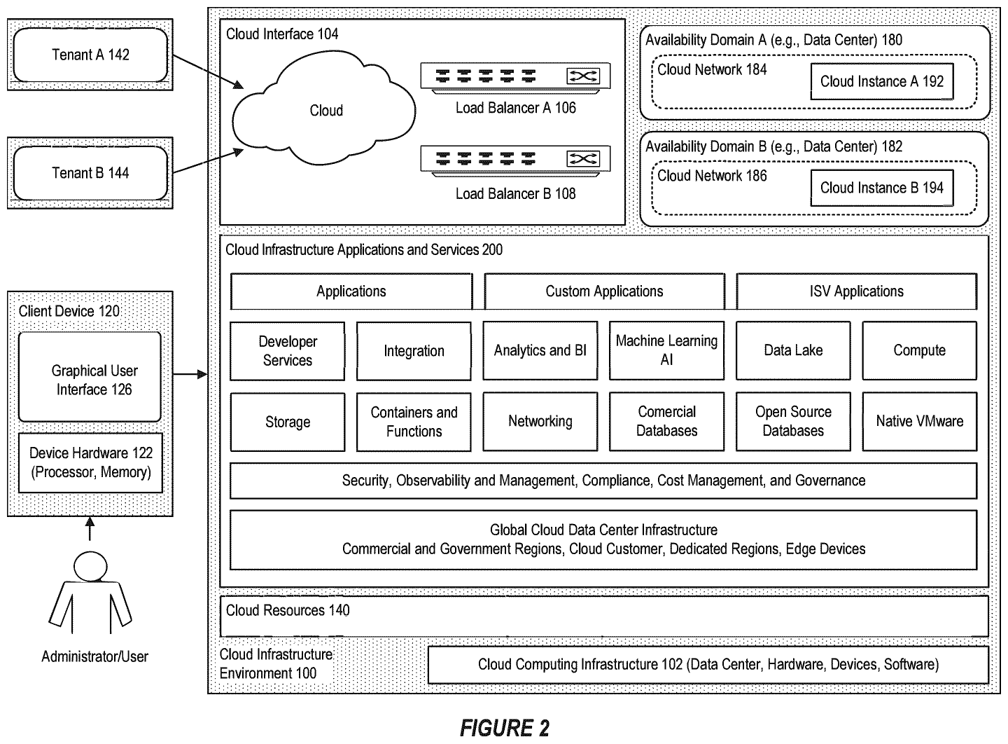

FIGS. 1 and 2 illustrate a system for providing a cloud infrastructure environment in accordance with an embodiment.

In accordance with an embodiment, the components and processes illustrated in FIG. 1, and as further described herein regarding various embodiments, can be provided as software or program code executable by a computer system or other type of processing device, for example, a cloud computing system.

The illustrated example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers A 106, B 108. Cloud interface 102 includes user interfaces and APIs provided by a cloud services provider for interacting with its cloud services. This includes tools and platforms that allow users and administrators to manage, configure, and monitor cloud resources and services. Cloud interface 102 may include a console, such as a web-based user interface that provides a visual way to interact with and manage cloud resources. Through the console, users may, for example, create, configure, and monitor cloud services like compute instances, databases, storage, and networking components. Cloud interface 102 may also include a command line interface for users who prefer to work with the cloud infrastructure using command-line tools. The CLI allows for scripting and automation of cloud management tasks in an embodiment.

In accordance with an embodiment, load balancer A 106 and load balancer B 108 are services that distribute incoming network traffic across multiple servers, instances, or other resources to ensure that no single resource bears too much demand. By spreading the requests evenly across the resources, load balancers enhance the responsiveness and availability of resources such as applications, websites, or databases. Load balancer A 106 and load balancer B 108 may be either public load balancers that are accessible from the Internet and used for distributing external traffic, or private load balancers that are used within a virtual cloud network (VCN) and are not accessible from the public Internet (and are therefore ideal for internal traffic distribution). In an embodiment, load balancer A 106 and load balancer B 108 are designed for high availability and fault tolerance and are implemented in a redundant configuration across multiple availability domains or fault domains.

In accordance with an embodiment, the cloud infrastructure environment supports the use of availability domains, such as availability domain A 180 and availability domain B 182, that enable customers to create and access cloud networks 184, 186, and run cloud instances A 192, B 194. In an embodiment, availability A 180 and availability domain B 182 may represent a data center, or a set of data centers located within a region. These availability domains may be isolated from each other, meaning that they may not share the same physical infrastructure such as power or cooling systems. This design provides a high degree of failure independence and robustness. In an embodiment, a fault domain may provide additional protection and resiliency within a single availability domain by grouping hardware and infrastructure within an availability domain that is isolated from other fault domains. This isolation may be in terms of electricity, cooling, and other potential sources of failure.

In accordance with an embodiment, a tenancy (a container for resources used by a tenant) can be created for each cloud tenant/customer, for example, tenant A 142, B 144, that provides a secure and isolated partition within the cloud infrastructure environment where the customer can create, organize, and administer their cloud resources. A cloud tenant/customer can access an availability domain and a cloud network to access each of their cloud instances. A tenancy in is isolated from other tenancies, ensuring that each customer's data and resources are secure and inaccessible to others. Within a tenancy, customers can create, manage, and organize a wide range of cloud resources, including compute instances, storage volumes, and networks. In Identity and Access Management (IAM) service enables the management of users, groups, and policies within a tenancy. Through IAM, customers can control who has access to their resources and what actions they can perform. The tenancy is also the level where billing and subscription management are handled. Usage and costs associated with the resources within a tenancy are tracked and billed collectively under that tenancy. Each tenancy may be associated with specific service limits and quotas for various resources. These limits may be used to help manage capacity and facilitate resource distribution across each tenant.

In accordance with an embodiment, a computing device, such as a client device 120 having a device hardware 122 (e.g., processor, memory) and graphical user interface 126, can enable an administrator or other user to communicate with the cloud infrastructure environment via a network, such as a wide area network, a local area network, or the Internet, to create or update cloud services.

In accordance with an embodiment, the cloud infrastructure environment provides access to shared cloud resources 140 via, for example, a compute resources layer 150, a network resources layer 160, and/or a storage resources layer 170. Customers can launch cloud instances as needed to meet compute and application requirements. After a customer provisions and launches a cloud instance, the provisioned cloud instance can be accessed from a client device such as client device 120.

In accordance with an embodiment, compute resources 150 can comprise resources, such as bare metal cloud instances 152, virtual machines 154, graphical processing unit (GPU) compute cloud instances 156, and/or containers 158. A bare metal instance represents a physical server with dedicated hardware that is fully allocated to a single tenant. A bare metal instance provides direct access to the server's processor, memory, storage, and other hardware resources. A virtual machine (VM) is a software emulation of a physical computer that runs an operating system and applications like a physical computer. VMs allow multiple operating systems to run on a single physical machine or across multiple machines. A hypervisor layer resides between the hardware and the virtual machines, allocating physical resources (like CPU, memory, and storage) to each VM. In an embodiment, GPU compute cloud instances provide GPUs along with traditional CPU resources. These instances are designed for tasks that require significant parallel processing power, making them ideal for applications like machine learning, scientific computing, 3D rendering, and video processing. In an embodiment, Containers 158 use a method of virtualization that allows for the running of multiple isolated applications on a single control host, virtualizing the operating system. Each container shares the host system's kernel but runs in an isolated user space, making containers lightweight and efficient.

The components of the compute resources 150 can be used to provision and manage bare metal compute cloud instances or provision cloud instances as needed to deploy and run applications, as in an on-premise data center. For example, in accordance with an embodiment, the cloud infrastructure environment can provide control of physical host (bare metal) machines within the compute resources layer that run as compute cloud instances directly on bare metal servers without a hypervisor.

In accordance with an embodiment, the cloud infrastructure environment can also provide control of virtual machines within the compute resources layer that can be launched, for example, from an image, wherein the types and quantities of resources available to a virtual machine cloud instance can be determined, for example, based upon the image that the virtual machine was launched from.

In accordance with an embodiment, the network resources layer can comprise several network-related resources, such as virtual cloud networks (VCNs) 162, load balancers 164, edge services 166, and/or connection services 168. In an embodiment, a virtual cloud network (VCN) is a customizable and private network in a cloud environment. A VCN provides a virtual version of a traditional network, including subnets, route tables, and gateways. It allows users to set up their cloud-based network architecture according to their requirements. In an embodiment, edge services 166 include services and technologies designed to bring computation, data storage, and networking capabilities closer to the location where they are needed. Edge services 166 may be used to optimize traffic, reduce latency, or provide other advantages.

In accordance with an embodiment, the storage resources layer can comprise several resources, such as data/block volumes 172, file storage 174, object storage 176, and/or local storage 178. Data/block volumes 172 provide unformatted block-level storage that can be used to create file systems that host databases or for other purposes requiring unformatted storage. File storage 174 provides a file system in an embodiment and may offer shared file systems that multiple instances can access concurrently using standard file storage protocols. Object storage 176 manages data as objects within storage buckets. Objects have certain attributes that may include data, metadata, and a unique identifier. Local storage 178 refers to storage devices that are physically attached to the host computer.

As illustrated in FIG. 2, in accordance with an embodiment, the cloud infrastructure environment can include a range of complementary cloud-based components, such as cloud infrastructure applications and services 200, that enable organizations or enterprise customers to operate their applications and services in a highly available hosted environment.

In accordance with an embodiment, a self-contained cloud region can be provided as a complete, e.g., Oracle Cloud Infrastructure (OCI), dedicated region within an organization's data center that offers the data center operator the agility, scalability, and economics of an e.g., OCI public cloud, while retaining full control of their data and applications to meet security, regulatory, or data residency requirements.

For example, in accordance with an embodiment, such an environment can include racks physically and logically managed by a cloud infrastructure provider (e.g., Oracle), customer's racks, access for cloud operations personnel for setup and hardware support, customer's data center power and cooling, customer's floor space, an area for customer's data center personnel, and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's (e.g., Oracle's) public cloud regions, for example, ERP, Financials, HCM, and SCM. A customer can seamlessly lift and shift legacy workloads using the cloud infrastructure provider's services (e.g., bare metal compute, VMs, and GPUs), database services (e.g., Oracle Autonomous Database), or container-based services (e.g., Oracle Container Engine for Kubernetes).

In accordance with an embodiment, a cloud infrastructure environment can operate according to an infrastructure-as-a-service (IaaS) model that enables the environment to provide virtualized computing resources over a public network (e.g., the Internet)

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components; example services include billing software, monitoring software, logging software, load balancing software, or clustering software. Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not, be a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries or daemons). This is often managed by the cloud infrastructure provider below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like).

In accordance with an embodiment, IaaS provisioning may refer to acquiring computers or virtual hosts for use and installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on others, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various geographic locations). However, in some examples, the infrastructure where the code will be deployed requires provisioning. In some instances, the provisioning can be done manually, a provisioning tool may be utilized to provision the resources, and/or deployment tools may be utilized to deploy the code once the infrastructure is provisioned.

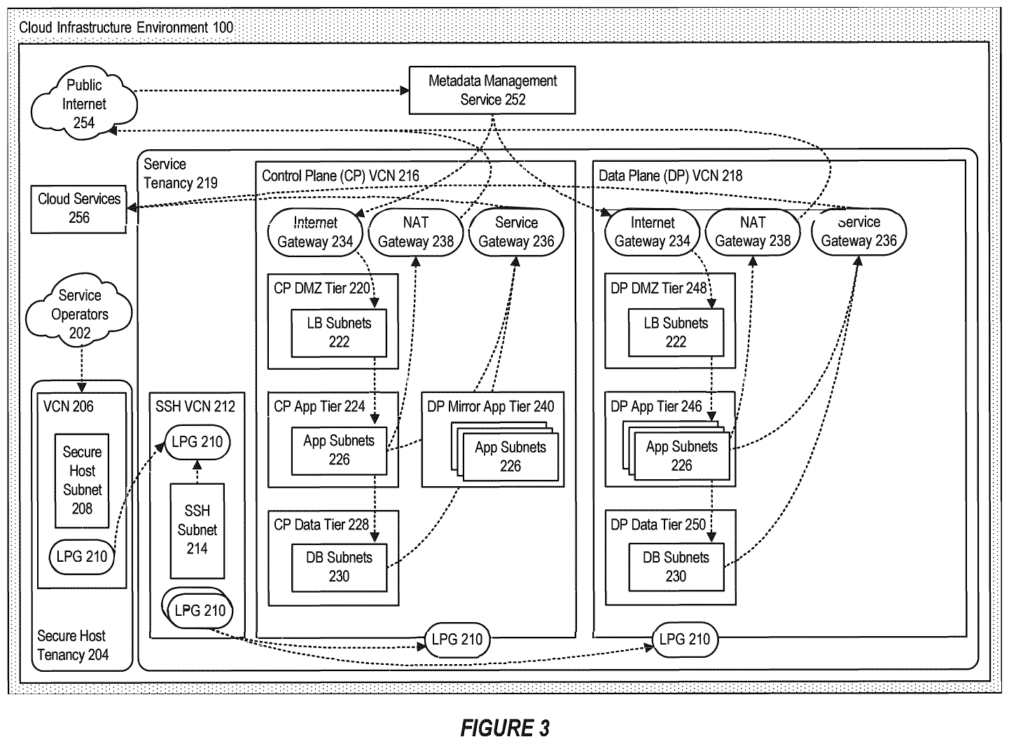

FIG. 3 illustrates an example cloud infrastructure architecture in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices that may be portable handheld devices (e.g., a telephone, a computing tablet, a personal digital assistant (PDA)) or wearable devices (e.g., a head mounted display), running software such as Microsoft Windows, and/or a variety of mobile operating systems, such as iOS, Android, and the like, and being Internet, e-mail, short message service (SMS), or other communication protocol enabled. Alternatively, the client computing devices can be general purpose personal computers including, for example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems such as Chrome OS. Additionally, or alternatively, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnets 222, a control plane app tier 224 that can include app subnets 226, and a control plane data tier 228 that can include database (DB) subnets 230 (e.g., frontend DB subnet(s) and/or backend DB subnet(s)). The LB subnet(s) contained in the control plane DMZ tier can be communicatively coupled to the app subnet(s) contained in the control plane app tier and to an Internet gateway 234 that can be contained in the control plane VCN. The app subnet(s) can be communicatively coupled to the DB subnet(s) contained in the control plane data tier, a service gateway 236, and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier, a data plane DMZ tier, and a data plane data tier. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way; the service gateway can make API calls to cloud services, and cloud services can send requested data to the service gateway. Generally, cloud services may not initiate API calls to the service gateway.

In accordance with an embodiment, the secure host tenancy can be directly connected to the service tenancy that may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example, create, read, update, or delete (CRUD) operations through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both that may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage that may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy that may be isolated from the public Internet.

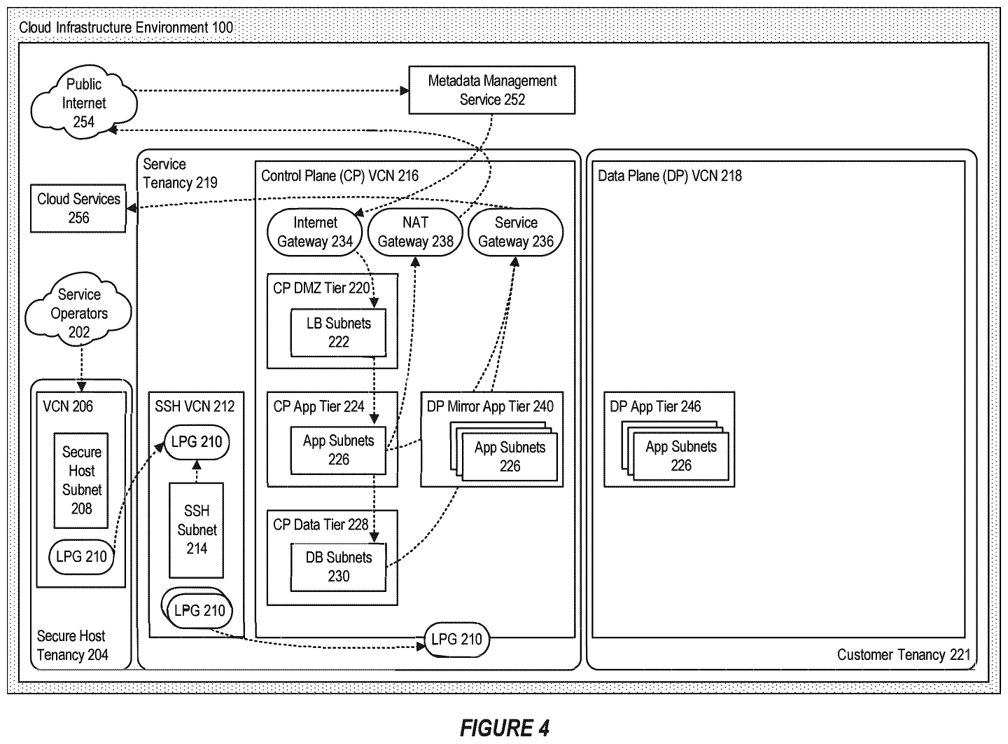

FIG. 4 illustrates another example of a cloud infrastructure architecture in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources provisioned in the control plane VCN contained in the service tenancy to be deployed or otherwise used in the data plane VCN contained in the customer tenancy.

In accordance with an embodiment, a customer of the cloud infrastructure provider may have databases that are managed and operated within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but the data plane mirror app tier may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, by the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with, Deployment 1 in Region 2.

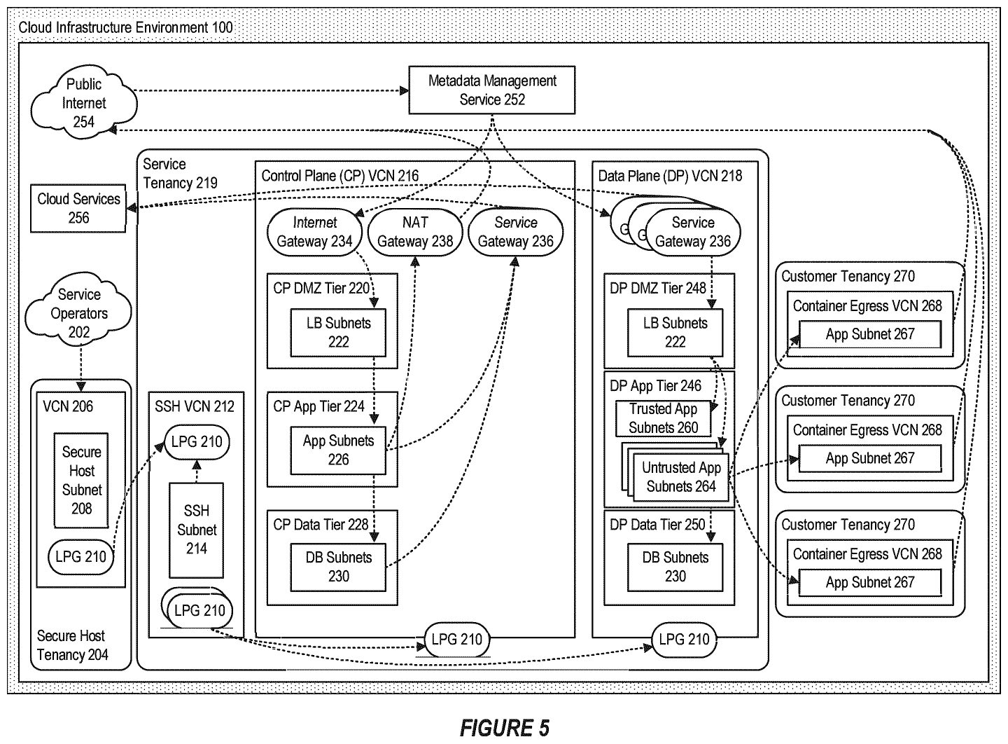

FIG. 5 illustrates another example of a cloud infrastructure architecture in accordance with an embodiment.

As illustrated in FIG. 5, in accordance with an embodiment, the trusted app subnets 260 can be communicatively coupled to the service gateway contained in the data plane VCN, the NAT gateway contained in the data plane VCN, and DB subnet(s) contained in the data plane data tier. The untrusted app subnets 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)) that may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s) and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled, or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

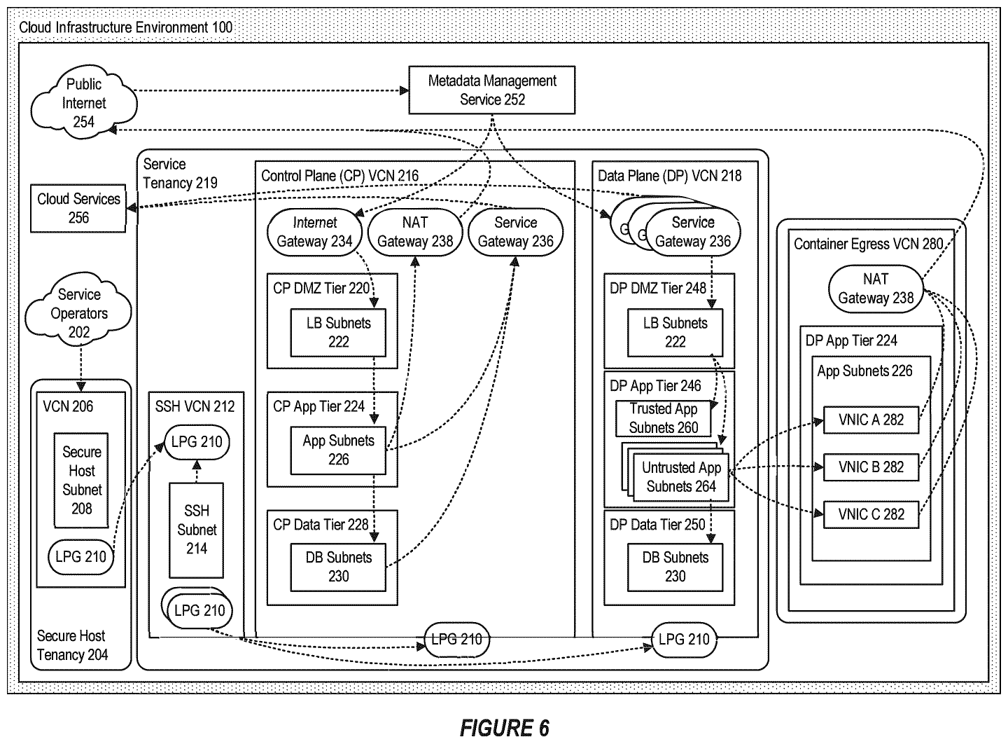

FIG. 6 illustrates another example of a cloud infrastructure architecture in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container and be communicatively coupled to an app subnet that can be contained in a data plane app tier that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that request a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining that the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Private Label Cloud Environments

In accordance with an embodiment, a cloud infrastructure environment can be used to provide dedicated cloud environments, for example, as one or more private label cloud environments for use by tenants of the cloud infrastructure environment in accessing subscription-based software products, services, or other offerings associated with the cloud infrastructure environment.

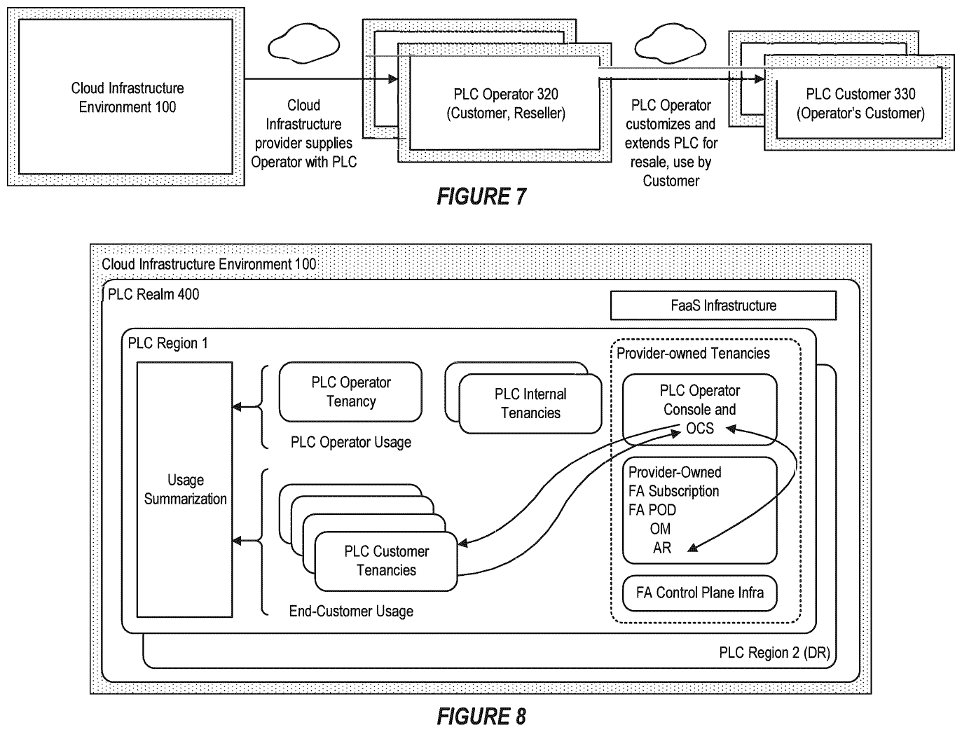

FIG. 7 illustrates how the system can provide dedicated or private label cloud environments for use by tenants or customers of a cloud infrastructure environment in accordance with an embodiment.

As illustrated in FIG. 7, in accordance with an embodiment, a cloud infrastructure provider (e.g., OCI) can supply a PLC operator 320, for example an OCI customer operating as a reseller, with one or more private label cloud (PLC) environments. The PLC operator/reseller can then customize and extend the private label cloud for use by (their) customer 330 for use in accessing subscription-based software products, services, or other offerings associated with the cloud infrastructure environment.

For purposes of illustration, examples of such subscription-based products, services, or other offerings may include various Oracle Cloud Infrastructure software products, Oracle Fusion Applications products, or other types of products or services that allow customers to subscribe to usage of those products or services.

FIG. 8 further illustrates the use of private label cloud realms for use by tenants or customers of a cloud infrastructure environment in accordance with an embodiment.

As illustrated in FIG. 8, in accordance with an embodiment, the system can include a cloud subscription service or component, such as an Oracle Cloud Subscriptions (OCS) service or component, that exposes one or more subscription management APIs for creating orders used to onboard new customers or to launch a workflow that creates a subscription and orchestrates billing and pricing service or other components for use with a PLC realm 400.

In accordance with an embodiment, when a PLC operator or their customer requests a PLC environment, the system creates a PLC realm for use with one or more provider-owned tenancies. A realm is a logical collection of one or more cloud regions that are isolated from each other and do not allow customer content to traverse realm boundaries to a region outside that realm. Each realm is accessed separately. PLC operators access cloud resources and services through a cloud tenancy. A cloud tenancy is a secure and isolated partition of a cloud infrastructure environment, and it only exists in a single realm. Within this tenancy, operators can access services and deploy workloads across all regions within that realm if policies allow.

In accordance with an embodiment, a first step in the process is to create an operator tenancy for the PLC operator before the realm and associated regions are turned over to them for subsequent management. The PLC operator then becomes the administrator of this tenancy with the ability to view and manage everything that happens within that realm, including their customer accounts and usage by those customers of cloud resources.

Generally, once the realm has been turned over or provided to the PLC operator, the cloud infrastructure provider cannot subsequently access the data within the operator tenancy unless the operator authorizes the cloud infrastructure provider to do so, for example, to provide troubleshooting for issues that may arise.

In accordance with an embodiment, the PLC operator can then create additional internal tenancies, intended for their own use internally, for example, to assess what the end customer experience will be, to provide a sales demo tenancy, or to operate a database for their own internal use. The operator can also create one or more customer tenancies that the end customer will be the administrator for. Cloud infrastructure usage metrics, for example, compute usage, storage usage, and usage of other infrastructure resources, may be consolidated by the operator, reflecting both operator usage and customer usage. Cloud infrastructure usage may be reported to the cloud infrastructure provider.

In accordance with an embodiment, a user interface or console can be provided that allows the PLC operator to manage its customer accounts and customer-offered services. A cloud infrastructure provider can also use a cloud infrastructure tenancy, for example, a Fusion Applications tenancy, to install any needed infrastructure services for use by the operator and their customers.

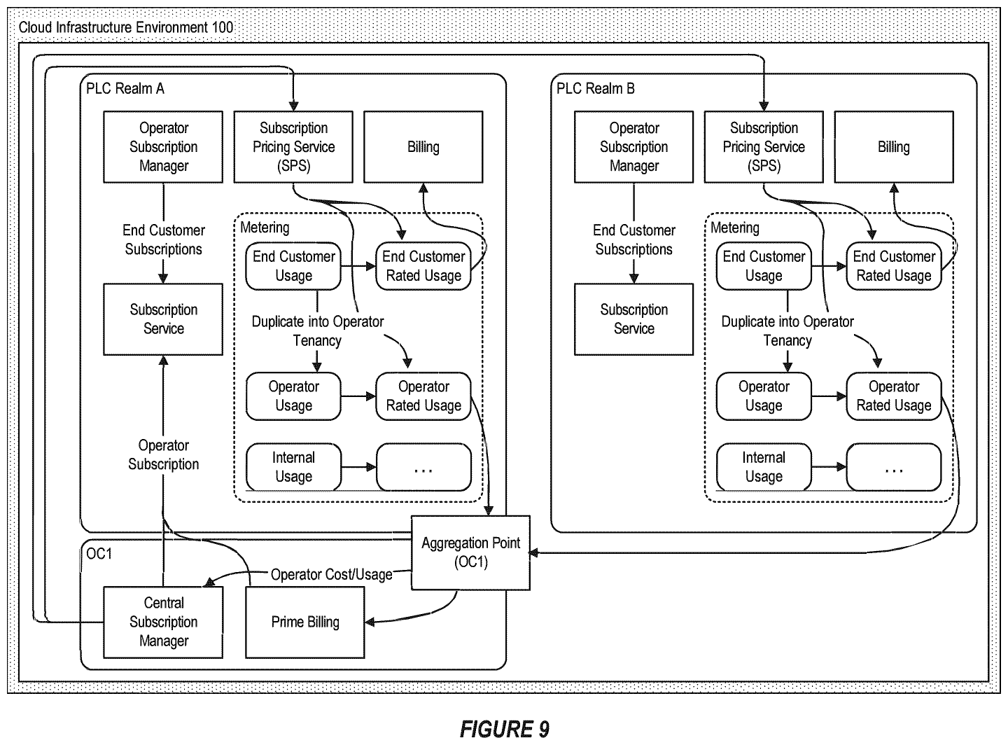

FIG. 9 further illustrates the use of private label cloud realms for use by tenants or customers of a cloud infrastructure environment in accordance with an embodiment.

As illustrated in FIG. 9, in accordance with an embodiment, a cloud subscription service or component exposes one or more subscription management APIs for creating orders used to onboard new customers or to launch a workflow that creates a subscription and orchestrates billing and pricing services or other components.

In accordance with an embodiment, the system can also include a billing service or component that operates upon a billing account or logical container of subscriptions and preferences used to produce an invoice for a customer.

In accordance with an embodiment, the system can also include a subscription pricing service (SPS) or component that operates upon a product catalog that defines the products that can be purchased by a customer. The subscription pricing service can also be used to provide a price list (e.g., a rate card) that the pricing service also owns.

In accordance with an embodiment, to support the sales process used to create a subscription in a PLC realm, products can be selected from a product hub. Once an order is created, a subscription is created in cloud subscription service that thereafter manages the life cycle of that subscription and provisions what needs to be provisioned in downstream services. The SPS component then manages the aspects of pricing and usage for use in charging the end cost to the PLC operator or their ability to charge their customers. Usage events are forwarded to the billing service or component, where, depending on the billing preferences of the subscription, invoices are created and pushed to an accounts receivables component.

In accordance with an embodiment, although the services that are offered in a realm report their usage to a metering service or component, such usage does not have any price associated with it. A rating process determines how much each specific event costs, for example, by applying rate cards, determines a unit and cost for that subscription, associates the cost to that record, and then forwards that to the billing service or component.

As further illustrated in FIG. 9, in accordance with an embodiment, a PLC operator may control multiple realms A, B. For, example an operator that operates in multiple countries may wish to operate a data center that is completely isolated for the United States of America and a separate data center that is completely isolated for Europe, for example, to address governance or regulatory requirements. In accordance with an embodiment, the usage associated with these multiple realms can be aggregated for use in billing the operator.

The examples of various systems illustrated above are provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Private Label Cloud Subscriptions

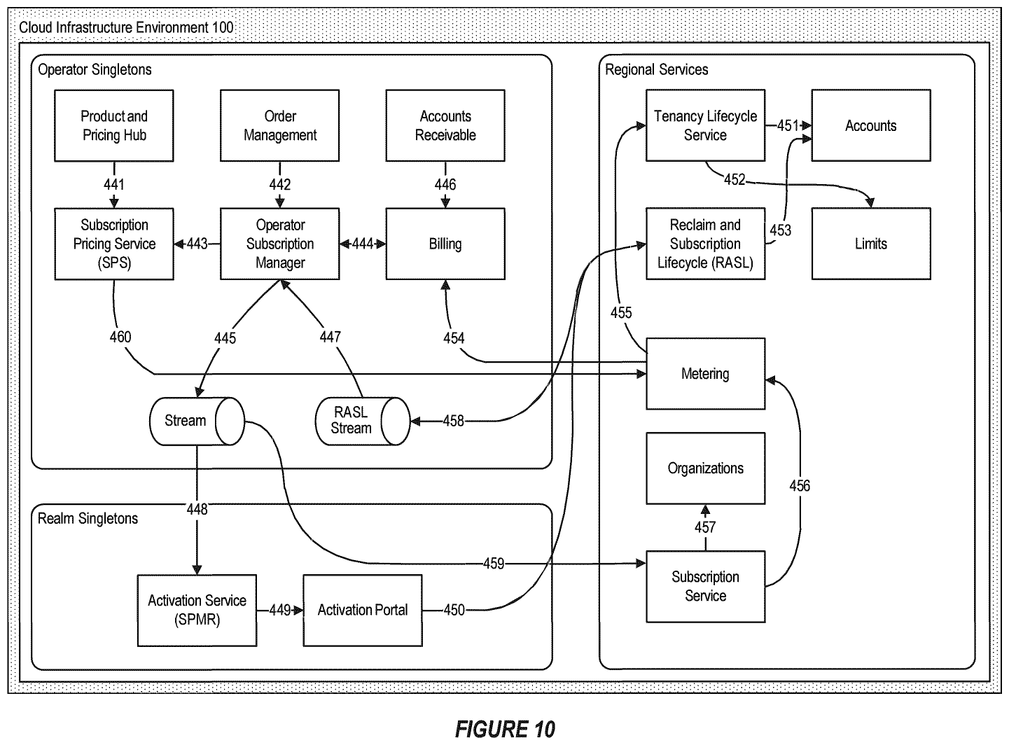

FIG. 10 illustrates a system for providing access to software products or services in a cloud computing or other computing environment in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various Oracle Cloud Infrastructure (OCI) software products, Oracle Fusion Applications products, or other types of products or services that allow customers to subscribe to usage of those products or services.

In accordance with an embodiment, a subscription can include artifacts, such as products, commits, billing model, and state. The cloud subscription service can expose one or more subscription management APIs for creating orders used to onboard new customers or to launch a workflow that creates a subscription and orchestrates creating the proper footprints in billing and pricing service or components as further described below.

In accordance with an embodiment, the billing service or component operates upon a billing account or logical container of subscriptions and preferences used to produce an invoice. Each billing account generates one or more invoices per billing cycle. The billing service includes a first pipeline that accepts usage and cost from a metering service or component. Usage may be accepted through a REST API or another interface. The billing service writes the usage to a database from which balances may be calculated and aggregated by the billing service or other services. The billing service may include a second pipeline responsible for taking the aggregated usage and commitments and calculating charges over one or more billing intervals.

In accordance with an embodiment, the subscription pricing service (SPS) or component operates upon a product catalog that defines the products that can be purchased by a customer. The product catalog forms the backbone of a price list (i.e., rate card) that the pricing service also owns. Rate cards are modeled as pricing rules on top of public list prices. The pricing service maintains a single price list for each product; new product prices can be added and existing prices changed. The price list has a full history, the latest version being the current rate card. Since some contracts may require a snapshot of the rate card be taken, the pricing service handles this by recording the time a customer's rate card is created and then querying the price list at that time.

In accordance with an embodiment, the SPS or pricing service is responsible for providing information about products, global price lists, and end customer subscription specific price lists and discounts. For example, in accordance with an embodiment, the SPS can sync product information from a product hub (e.g., an Oracle Fusion Product Hub) and a global price list from a pricing hub (e.g., an Oracle Fusion Pricing Hub).

In accordance with an embodiment, the cloud subscription service operates as an upstream service to receive new order requests, for example, from an Oracle Fusion Order Management environment. The cloud subscription service can provide subscription information to the SPS service. Subscription details like time of quote, configuration, and subscription type (Commitment, PayG) help SPS to determine an effective base price (Rate Card) for the subscription. The cloud subscription service can also send discounts for subscriptions received, for example, from Oracle Fusion Order Management, that SPS stores as a pricing rule entity.

In accordance with an embodiment, the SPS service runs as a background process to manage a rate cards service or component responsible for generating rate cards for new subscriptions and updating when new price changes occur. The SPS service can expose APIs to access rate cards and pricing rules. A metering in-line rating engine can utilize these APIs to get subscription-specific rate cards and pricing rules using this data for cost calculations.

In accordance with an embodiment, additional SPS components can include, for example, a Pricing/Product Hub Oracle Integration Cloud (OIC) integration component, that allows a PLC operator entity providing subscription-based products, services, or other offerings within the environment to manage their product and price list, for example, as provided by an Oracle Fusion Product Hub and Oracle Fusion Pricing Hub, respectively.

For example, in accordance with such an embodiment, an SPS OIC product integration flow can listen to create/update events in the Product Hub and make calls to an SPS product API. Similarly, an SPS OIC pricing integration flow can pull new price list creations from the Pricing Hub and call respective SPS pricing APIs.

In accordance with an embodiment, the system can also include an SPS core module that provides APIs to manage and access pricing entities. Pricing can be accessed by internal services, such as an inline rating engine.

In accordance with an embodiment, the system can also include a rate card manager component. The SPS service maintains the single base price for a product at a given time. However, product prices for subscriptions are dependent on a base price at quote configuration time and price list change policy attributes of subscriptions. The SPS service internally maintains the price to be used for subscriptions using these properties. Such price lists are grouped in a rate card. The rate card manager can create and maintain the rate card as well as listen to price list changes and update existing rate cards with the new price. It also listens to new subscriptions and assigns the rate card based on subscription properties.

In accordance with an embodiment, the system can also include a rule decoder engine. The SPS service is responsible for managing pricing rules for a subscription, including discounts offered to an end customer. Pricing rules eligibility can be based on attributes of Products, like Discount group, Product Category, or specific SKUs. Internally, SPS needs to identify the list of products these rules will be applicable. To accomplish this, the rule decoder engine can compile the pricing rules in a format such that an in-line rating engine can consume for cost calculation. This compilation process can be triggered when products or pricing rules get created/updated.

As illustrated by way of example in FIG. 10, in accordance with an embodiment: at 441, a product and price information managed in, e.g., Fusion Applications, is sent to the SPS component. At 442, orders are sent to the cloud subscription service component to create subscriptions, rate cards, and billing accounts. At 443, pricing configuration and pricing rules are sent to SPS for new orders. At 444, the cloud subscription service is used to set up a billing account in the billing service or component. At 445, the cloud subscription service publishes events to a cloud infrastructure streaming component. At 446, charge data is sent to an accounts receivable component to generate invoices. At 447, cloud subscription service consumes reclaim and subscription lifecycle (RASL) events from cloud infrastructure streaming. At 448, an activation service reads the cloud subscription service event stream. At 449, a customer gets activation data from a portal. At 450, a tenancy lifecycle service provisions a tenancy as part of the subscription activation. At 451, the tenancy lifecycle service creates an accounts footprint during account provisioning. At 452, the tenancy lifecycle service sets a limits template during account provisioning. At 453, the accounts component acts as a downstream RASL client to handle legacy reclamation. At 454, aggregated cost and usage is sent to the billing service or component. At 455, an organization can create child tenancies using the tenancy lifecycle service. At 456, a metering service or component gets subscription mapping data. At 457, the subscription service gets organization data for subscription mappings. At 458, RASL reads cloud subscription service event stream. At 459, the subscription service reads cloud subscription service event stream; and at 460, the metering service or component gets a rate card data for each subscription that can then be used in charging the end cost to the PLC operator or their ability to charge their customers.

The above example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### 2. Tenancy Link System Architecture

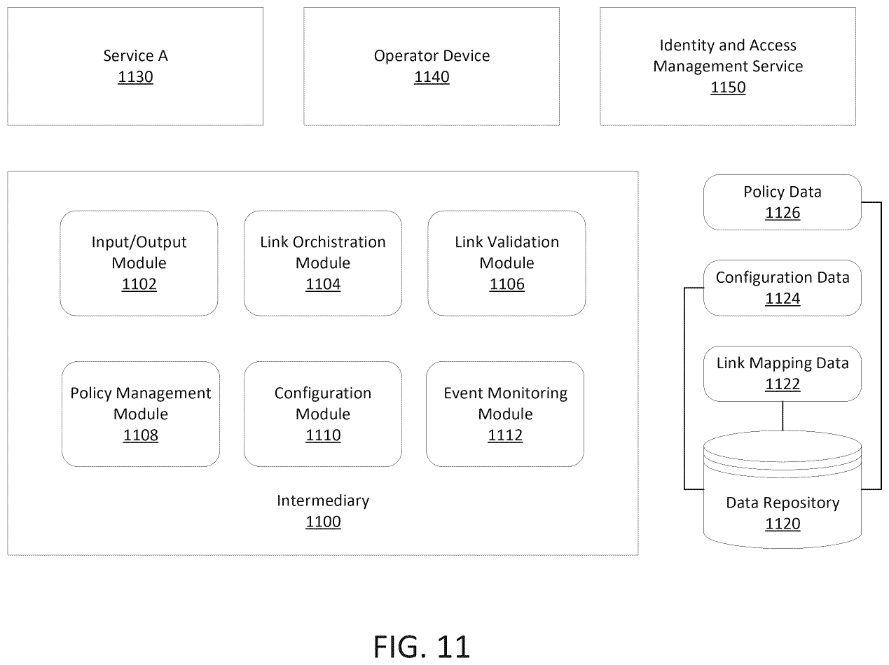

FIG. 11 illustrates a tenancy link system architecture in accordance with one or more embodiments. As illustrated in FIG. 11, intermediary 1100 includes input/output module 1102, link orchestration module 1104, link validation module 1106, policy management module 1108, configuration module 1110, and event monitoring module 1112. FIG. 11 illustrates data repository 1120, that includes link mapping data 1122, configuration data 1124, and policy data 1126. FIG. 11 also illustrates service A 1130, operator device 1140, and identity and access management service 1150. In one or more embodiments, the intermediary 1100 may include more or fewer components than the components illustrated in FIG. 11. In one or more embodiments, intermediary 1100 may include components that are illustrated as external to intermediary 1100, such as data repository 1120, service A 1130, operator device 1140, and/or identity and access management service 1150. The components illustrated in FIG. 11 may be local to or remote from each other. The components illustrated in FIG. 11 may be implemented in software and/or hardware. Each component may be distributed over multiple applications and/or machines. Multiple components may be combined into one application and/or machine. Operations described with respect to one component may instead be performed by another component.

In accordance with one or more embodiments, input/output module 1102 is configured to manage data integrity and quality as it enters intermediary 1100 by incorporating initial checks and validations. These checks and validations ensure that incoming data meet predefined quality standards, like checking for missing values, ensuring consistency in data formats, and verifying data ranges and types. In accordance with one or more embodiments, input/output module 1102 is configured to handle the distribution and exportation of outputs for consumption by other modules, systems, or by users. For example, input/output module 1102 may be configured to format outputs into user-friendly and accessible formats, such as reports, visualizations, or data files compatible with other systems. Input/output module 1102 also ensures secure and efficient transmission of these outputs to end-users or other systems in an embodiment and may employ encryption and secure data transfer protocols to maintain data confidentiality.

In accordance with one or more embodiments, link orchestration module 1104 is configured to create and maintain tenancy links. A tenancy link is a link between two tenancies indicating that there is a relationship between the tenancies. In an embodiment, link orchestration module 1104 may create a tenancy link between a governing tenancy and a subject tenancy. A governing tenancy is a tenancy associated with governing entity that may be used to manage and oversee policies and configurations that are applied within one or more subject tenancies. The governing tenancy may be used to manage resources related to billing, resource allocation, compliance, security, efficient resource management, or any other activity occurring within subject tenancies, so long as management delegation has been approved by the corresponding subject tenancy. A subject tenancy is a tenancy that has delegated certain responsibilities to a governing tenancy, adhering to the policies provided by the governing tenancy while maintaining a degree of independence for specific projects, departments, or clients within the organization. This structure allows for centralized governance while enabling decentralized management, facilitating the effective distribution and oversight of resources within large-scale cloud environments.

In accordance with one or more embodiments, link orchestration module 1104 stores link mapping data 1122 in data repository 1120. Link mapping data 1122 includes mappings between tenancies in an embodiment. In accordance with one or more embodiments, link mapping data 1122 identifies the governing tenancy, the subject tenancy, link status, and a feature, application, system, and/or service associated with the link. For example, a tenancy link may be active or inactive and may be associated with a particular feature such as a security feature available in the cloud computing environment.

In accordance with one or more embodiments, link orchestration module 1104 is configured to facilitate communication with systems or operators associated with tenancies. Link orchestration module 1104 is configured to manage a tenancy link handshake process to ensure that assent is provided from authorized representatives or services for both the governing tenancy and the subject tenancy before a tenancy link is created. For example, link orchestration module 1104 may receive a request to generate a link from an operator or service associated with a governing tenancy, indicating assent on the part of the governing tenancy. Link orchestration module 1104 is configured to obtain approval from the subject tenancy operator or service before creating a tenancy link between the governing tenancy and the subject tenancy.

In accordance with one or more embodiments, link orchestration module 1104 is configured to facilitate the activation and deactivation of tenancy links. For example, if an event occurs that results in a need to deactivate a tenancy link, link orchestration module 1104 updates the link mapping data associated with the link to reflect the inactive status. Likewise, if an event occurs that results in a need to activate a tenancy link, link orchestration module 1104 updates the link mapping data associated with the link to reflect the inactive status.

In accordance with one or more embodiments, link validation module 1106 is configured to determine if a link is present between a governing tenancy and a subject tenancy. For example, a service associated with the governing tenancy may make a configuration request associated with a subject tenancy. If link validation module 1106 determines that there is no active link between the governing tenancy and the subject tenancy, the request is denied. If link validation module 1106 determines that there is an active link between the governing tenancy and the subject tenancy, link validation module 1106 may issue a resource principal token to the requesting service, with the origin of the resource principal being the subject tenancy.

In accordance with one or more embodiments, a resource principal refers to a specific resource within a cloud environment that can act as an identity to perform actions or access other resources. This allows the resource itself, such as a virtual machine, a service, a storage bucket, or a database, to have permissions and perform operations autonomously, similar to how a user or service account operates. A resource principal token is a type of security token that represents the identity of the resource principal. This token is used to authenticate and authorize the resource principal to perform actions or access other resources within the cloud environment. The token contains information about the resource principal's identity and its permissions, ensuring that the resource can securely interact with other services and resources according to its defined policies. The resource principal token forms a basis for authorization for the service associated with the governing tenancy to take actions within the subject tenancy. In an embodiment, the resource principal token is associated with a feature that is identified in the link data for the active link. In accordance with one or more embodiments, the resource principal token is provided to the requesting service associated with the governing entity.

In accordance with one or more embodiments, link validation module 1106 is configured to obtain link mapping data 1122 from data repository 1120. For example, link mapping data 1122 indicates if there is a tenancy link between the governing tenancy and the subject tenancy. In addition, link mapping data 1122 indicates if a tenancy link is active, not active, or in another state such as a pending status.

In accordance with one or more embodiments, link validation module 1106 is configured to perform security checks to verify the authenticity of requests from governing tenancies. For example, link validation module 1106 may ensure that the governing tenancy in the request is the same governing tenancy associated with the service that issued the request. In other embodiments, link validation module 1106 is configured with rules that require requests to come from the service associated with the feature identified in the request. In an embodiment, other validation rules may be applied by link validation module, including rules related to subject tenancy validation.

In accordance with one or more embodiments, policy management module 1108 is configured to manage targeted policies and policy templates that support features registered with intermediary 1100. For example, a feature may be a security service that is registered with intermediary 1100, allowing governing tenancies to select the security service feature for use in connection with managing subject tenancies. For governing tenancies to use a registered feature, policies associated with the feature may need to be configured with identity and access management service 1150. In an embodiment, policy templates associated with the feature are provided to intermediary 1100 during the feature registration process. For example, policies may be needed to allow a service to access or perform actions using resources associated with the subject tenancy, such as logs, compartments, databases, VCNs, buckets, and other resources.

In accordance with one or more embodiments, policy management module 1108 stores policy templates as policy data 1126 in data repository 1120. A policy template is a representation of a configuration for an identity and access management (or similar) policy. A policy template may be used to generate and store a policy that provides appropriate access for a resource principal. A policy that is generated using a policy template may be stored in policy data 1126 and may be pushed to identity and access management service 1150 to enable a feature such as a service associated with a governing tenancy. In accordance with an embodiment, policy management module 1108 is configured to instantiate a policy associated with a registered feature in response to an indication or trigger by link orchestration module 1104 that a successful handshake between a governing tenancy and a subject tenancy has occurred.

In accordance with one or more embodiments, configuration module 1110 is configured to manage the configuration of intermediary 1100. Configuration module 1110 may include one or more interfaces that allow users and/or systems to view or alter configuration data 1124. Other modules in intermediary 1100 rely on configuration module 1110 to access and provide accurate configuration data as needed. For example, a module within intermediary 1100 may need to access information about a registered feature to determine the storage location for policy templates, the naming convention for resource principals, or any other configuration-related information or data. An operator with access to intermediary 1100 may access configuration module 1110 to configure intermediary 1100 in an embodiment. For example, an operator may define requirements for registering a feature with intermediary 1100, configure the location for storing information such as policy templates, define session timeout parameters, define security parameters, and define required tenancy relationships or other requirements for generating tenancy links. Configuration information is stored in configuration data 1124 in an embodiment.

In accordance with one or more embodiments, configuration module 1110 may store configuration information associated with one or more governing tenancies. A service associated with a governing tenancy may store tenancy-specific rules regarding links between tenancies. For example, a rule may indicate that only one governing tenancy may be linked to a subject tenancy at a time, or there may only be one governing tenancy per feature. In an embodiment, other modules in intermediary 1100 may include separate configuration modules.

In accordance with one or more embodiments, event monitoring module 1112 is configured to monitor activities associated with intermediary 1100 and generate log files. For example, in an embodiment event monitoring module 1112 detects and stores information related to the assignment of a resource principal, generates requests to create a link, manages the deployment of policies to an identity and access management system, handles the acceptance of a handshake, and performs other activities that may be subject to audit requirements. Log files are stored in data repository.

In accordance with one or more embodiments, service A 1130 represents a service that is registered as a feature with intermediary 1100. Any service that a governing tenancy could use to manage resources associated with a subject tenancy may be represented by service A 1130. As an example, service A 1130 could be an Oracle Cloud Guard instance in one or more embodiments. In an embodiment, an operator associated with a governing tenancy may use operator device 1140 (a computing device) to access and configure service A 1130. Service A 1130 is configured to use a resource principal provided by intermediary 1100 to access and/or manage resources associated with one or more subject tenancies. For example, service A 1130 may continuously monitor log files associated with network or storage systems and other resources associated with a subject tenancy. Service A may also access configurations, activities, and security information. It may examine a wide range of resources, including compute instances, storage buckets, virtual cloud networks (VCNs), databases, and security groups. Service A 1130 may access resource configurations, network traffic logs, and system activities to generate billing reports, identify potential security risks, or perform other administrative or tenancy-management tasks. In accordance with one or more embodiments, the access afforded to service A 1130 is based on a resource principal assigned to service A 1130 by intermediary 1100 and policies generated using policy templates, the policies being instantiated by intermediary 1100 on identity and access management service 1150 in the subject tenancy.

In accordance with one or more embodiments, identity and access management system 1150 serves as a platform for managing identities and accessing privileges. This system is used to store, update, and manage access data that define the roles, permissions, and policies associated with the operators and systems. When a service attempts to perform operations associated with a subject tenancy, for example, identity and access management system 1150 performs a verification operation to determine if the service is authorized to perform the operations. This process entails a comparison of the resource principal presented by the service and its requested access rights against the resource associated with the subject tenancy.

In accordance with one or more embodiments, identity and access management system 1150 incorporates authentication, authorization, and auditing mechanisms. Authentication processes are designed to confirm the identity of operators and systems by requiring them to present credentials that may include passwords, security tokens, or other verification methods. Following successful authentication, the authorization mechanism assesses if the access request aligns with the roles and permissions associated with the authentication information presented. For example, if a service presents a resource principal token, identity and access management system 1150 verifies that the associated resource principal is authorized to access the requested resource. The identity management system's auditing features facilitate monitoring and logging access attempts and activities, providing a detailed record for security analysis and compliance auditing.

In accordance with one or more embodiments, identity and access management system 1150 may integrate with other security and operational tools within the organization. For example, when integrating with directory services, identity and access management system 1150 can automatically synchronize authorization and authentication data, ensuring that access rights are accurately reflected across the systems. Additionally, identity and access management system 1150 may employ advanced security protocols and encryption standards to protect sensitive information and communications, further securing the authentication and authorization processes.

In one or more embodiments, data repository 1120 is any type of storage unit and/or device (e.g., a file system, database, collection of tables, or any other storage mechanism) for storing data. Furthermore, data repository 1120 may include multiple different storage units and/or devices. The multiple different storage units and/or devices may or may not be of the same type or located at the same physical site. Furthermore, data repository 1120 may be implemented or executed on the same computing system as intermediary 1100. Additionally, or alternatively, data repository 1120 may be implemented or executed on a computing system separate from intermediary 1100. The data repository 1120 may be communicatively coupled to intermediary 1100 via a direct connection or via a network.

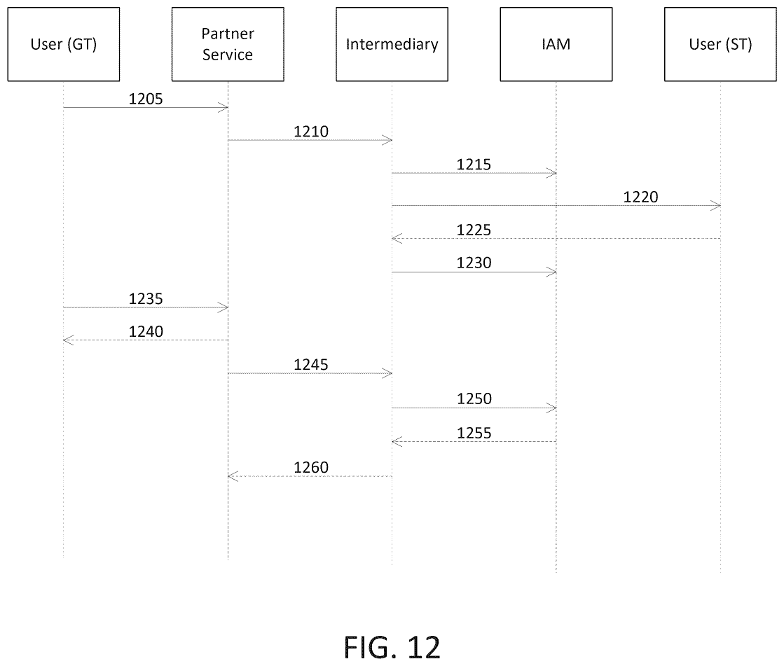

Information describing intermediary 1100 may be implemented across any of components described in FIG. 11. However, this information is illustrated within the data repository 1120 for purposes of clarity and explanation. In one or more embodiments, intermediary 1100 refers to hardware and/or software configured to perform operations described herein for intermediary 1100. Examples of operations for intermediary 1100 are described below with reference to FIG. 12.

In an embodiment, intermediary 1100 and other systems described herein are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, one or more systems described herein may include a user interface. A user interface refers to hardware and/or software configured to facilitate communications between a user and the corresponding system. A user interface renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of a user interface are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the user interface is specified in one or more other languages, such as Java, C, or C++.

### 4. Controlling Governing Tenancy Access to Subject Tenancy Resources

A detailed example is described below for purposes of clarity. Components and/or operations described below should be understood as one specific example that may not be applicable to certain embodiments. Accordingly, components and/or operations described below should not be construed as limiting the scope of any of the claims.

FIG. 12 illustrates an example set of operations for controlling governing tenancy access to subject tenancy resources in accordance with one or more embodiments. One or more operations illustrated in FIG. 12 may be modified, rearranged, or omitted. Accordingly, the particular sequence of operations illustrated in FIG. 12 should not be construed as limiting the scope of one or more embodiments.

In accordance with one or more embodiments, an intermediary may be configured to manage governing tenancy access to subject tenancy resources. For example, an actor associated with a governing tenancy may request that a partner service associated with a governing tenancy may be on-boarded to the intermediary using a process that makes that partner service available to subject tenancies. The request may also indicate the subject tenancies that should be offered to the partner service. One example of such a partner service is a security service such as Oracle CloudGuard. By allowing a security service associated with a governing tenancy to manage security for a subject tenancy or a set of subject tenancies, the subject tenancies may benefit from the expertise of the users associated with the governing tenancy that configured the security service. The users of the subject tenancies will also benefit from the security service itself without the need for managing security for the subject tenancy. In such a scenario, a governing tenancy may efficiently provide security services for a multitude of organizations across many tenancies.

In an embodiment, a partner service that may be desirable for subject tenancies can be onboarded using an intermediary. Before a partner service is made available to potential subject tenancies, the partner service is configured by a user associated with the governing tenancy (Operation 1205). For example, policy templates may be created and registered for the partner service. Policy templates define IAM policies to be used by an IAM service to ensure that the access provided to the partner service is sufficient for the partner service to perform the expected operations. For example, a policy template may indicate that the partner service is able to create rules and policies used to define and manage security configurations, detections, and responses on behalf of the subject tenancy. This will allow the partner service to customize and automate security management to align with the governing tenancy security requirements and compliance standards in an embodiment. In other embodiments, other IAM policies may be included in templates.

In an embodiment, there are no restrictions on the types of IAM policies that may be represented in a policy template. The templates are tailored to accomplish the specific business strategy (also referred to as a feature) provided by the partner service that is associated with the governing tenancy. For example, a partner service that is associated with the governing tenancy may provide accounting features to the subject tenancy in accordance with the configuration implemented by a user of the governing tenancy. In such an embodiment, the IAM policy template may indicate that access to certain accounting-related data, such as tenancy resource usage, rates, and other information, is required for the partner service to perform the desired functions.

In accordance with one or more embodiments, the partner service to be made available via the intermediary sends an on-boarding request to the intermediary (Operation 1210). The on-boarding request includes the feature name associated with the partner service/feature being provided and the IAM policy template(s) associated with the feature. The IAM policy templates are stored by the intermediary during the on-boarding phase.

In accordance with an embodiment, the intermediary registers a resource principal with the IAM service (Operation 1215). This step establishes a unique identity for the partner service that is associated with the governing tenancy. In an embodiment, the resource principal is unshared, meaning that the resource principal will only be used with the particular partner service it was created for. Using an unshared resource principal allows administrators to track actions that are performed using the unshared resource principal with the assumption that the actions were performed by the particular partner service using the unshared resource principal. In an embodiment, the resource principal is shared, negating the benefits associated with using an unshared resource principal. In accordance with one or more embodiments, at the time of the registration of the resource principal, the resource principal is not associated with a tenancy. In other words, the resource principal is an identity with potential permissions, but the resource principal is not linked to any specific tenancy at this stage.

In accordance with one or more embodiments, the intermediary initiates an invitation to create a link between the governing tenancy and a subject tenancy for the feature (Operation 1220). For example, a user or a partner service associated with the governing tenancy may generate and send a message to the intermediary indicating a desire to manage security services on behalf of the subject tenancy using a security service. The intermediary orchestrates a handshake process that is used to ensure that the link is agreed upon by both parties. For example, the intermediary may generate and send a message to a user, service, or device associated with the subject tenancy that indicates the request originating from the governing tenancy. The message may indicate a governing tenancy identifier and the feature or partner service that the governing tenancy will use on behalf of the subject tenancy. The invitation message from the governing tenancy may be delivered to a user associated with the subject tenancy via email, a user interface, or any other message delivery mechanism. The invitation message includes a mechanism for acceptance or denial of the invitation, such as a link, user interface element, or instructions, to indicate a preference in a text response. In an embodiment, an invitation identifier is provided or embedded within invitations to allow the intermediary to track the status of invitations. An invitation identifier may be referenced or included in a response to an invitation.

In accordance with one or more embodiments, a user or service associated with the subject tenancy responds to the invitation to create a link with the governing tenancy for the identified partner service/feature, indicating acceptance or rejection (Operation 1225). The intermediary relies on the authority of the user accepting the invitation to perform subsequent operations. For example, to manage IAM policies associated with the subject tenancy, the intermediary obtains permission from a subject tenancy user that is authorized to make policy changes.

In accordance with one or more embodiments, once the invitation is accepted, the intermediary instantiates/registers, deploys, and locks the IAM policy templates (Operation 1230). To instantiate the template, the intermediary uses the policy template to create a policy that includes the proper parameter values. For example, the policy template may include parameters that are deployment-specific, such as those related to a particular subject tenancy and that represent the specific relationship between the tenancies being linked. This may be referred to as a link-specific identity and access management policy. Once the template has been instantiated to generate an IAM policy, the resulting IAM policy is then deployed to the subject tenancy. This involves a submission of the IAM policy by the intermediary to the IAM service. The IAM service interprets the submission and creates, updates, or deletes the IAM resources as specified. This may include creating user accounts, defining roles and policies, and establishing permissions.

In accordance with one or more embodiments, the IAM policies are locked once they are deployed. This means that the policies are restricted in numerous ways to ensure they cannot be modified without proper authorization and are inoperable until a triggering event occurs. This protects policies from accidental or malicious changes. For example, IAM policies can include conditions that restrict the actions that can be performed on the policy itself. For example, a policy may deny the actions that update policies unless certain conditions are met, such as being within a specific IP range or requiring multi-factor authentication (MFA). Triggering events, such as those related to security, may also result in unlocking policies. In accordance with an embodiment, the IAM policies will allow the on-boarded partner service associated with the governing tenancy to execute business logic in a delayed fashion when conditions are met without relying on an authenticated but soon-to-expire active session.

In accordance with one or more embodiments, the acceptance of the governing tenancy link request by a user or service associated with the subject tenancy triggers the creation of a tenancy link. A tenancy link is a link between two tenancies indicating that there is a relationship between the tenancies. The tenancy link can be stored by the intermediary as a file, database entry, in memory, or by using some other storage mechanism. The tenancy link identifies the governing tenancy, the subject tenancy, and the feature/partner service in an embodiment. For example, the tenancy link is specific to a particular partner service, meaning that the tenancy link may indicate, for example, that there is a relationship between the governing tenancy and the subject tenancy for a security service but not for an accounting service. In an embodiment, a separate tenancy link is recorded for each partner service to facilitate separation and greater control over tenancy links and associated services, among other advantages. In another embodiment, a single tenancy link indicates the governing tenancy, the subject tenancy, and the partner services/features that the link is valid for.

In accordance with an embodiment, once a tenancy link has been established, users associated with the subject tenancy are unable to disable the tenancy link unilaterally. For example, if a tenancy link is established between a governing tenancy and a subject tenancy for a security service, users associated with the subject tenancy are prohibited from removing governing tenancy oversight with respect to the security service. In such a case, the inability to alter the tenancy link ensures that if there is a security even that compromises user credentials related to the subject tenancy, the actor with the compromised credentials will be unable to disable security features that may offer some protection to the tenancy. In accordance with one or more embodiments, the intermediary may receive a link deactivation request, resulting in removing or altering the link mapping data.

In accordance with one or more embodiments, a user of the governing tenancy deploys a rule or a scheduled task to the partner service (Operation 1235). For example, in the context of a security service, the user of the governing tenancy may deploy a scheduled task for the security service to perform a log analysis operation at a specified interval (e.g., every 12 hours). As a more specific example related to the use of Oracle CloudGuard, a user associated with the governing tenancy may create “recipes” for the CloudGuard service. A recipe indicates rules that are interpreted by the CloudGuard service. For example, the recipe may require that the service scan to see if there are any public IP (Internet Protocol) ports exposed by any of the services in the subject tenancy or tenancies governed by the governing tenancy, and if the CloudGuard service detects open IP ports, the CloudGuard service may generate an alarm or cause another service to generate an alarm that indicates a potential security vulnerability. A rule may also be deployed to require that an email be sent to an administrator of the subject tenancy if a security vulnerability or event is detected.

In accordance with one or more embodiments, a variety of other rules and tasks may be created by a user of the governing tenancy. For example, an alert, request, or a command may satisfy the conditions of a rule that has been deployed to the partner service. As another example, a rule may take the form of a restriction such as a region restriction. If the user of a governing tenancy deploys a rule that identifies a list of regions a tenancy may subscribe to, then the partner service associated with the tenancy link may deploy restrictions on the regions available to resources in the subject tenancy. The deployment of such rules takes place within the governing tenancy with a user or resource associated with the governing tenancy deploying rules to the partner service associated with the governing tenancy that is referenced in a tenancy link.

In accordance with one or more embodiments, when a rule is deployed to the partner service, a unique identifier of the resource (a resource identifier) is returned by the partner service to the user (Operation 1240). The resource identifier is referenced by the partner service later when the partner service interacts with the subject tenancy. Since the partner service provides the resource identifier with interactions with the subject tenancy, an audit log can be made, indicating a partner service that performed actions using the resource principal, the governing tenancy, and the subject tenancy. The resource principal is explicitly bound to the subject tenancy, so activity performed using the resource principal will appear as though it originated from within the tenancy. By connecting the resource principal with the resource identifier, the audit log will provide an accurate view of the actors associated with actions performed within the subject tenancy.

In accordance with one or more embodiments, a triggering event causes the partner service to initiate activity related to the subject tenancy to perform an operation related to the triggered rule. For example, if a rule requires that the partner service perform a security-related scan of the subject tenancy every 12 hours, the partner service will attempt to perform the network scanning operation when required. The partner service initiates the activity by connecting with the intermediary with a request for a resource principal token (Operation 1245). The partner service provides the intermediary with information relating to the link between the governing tenancy and the subject tenancy to obtain the resource principal. The information includes a reference to the governing tenancy, a reference to the subject tenancy, and a reference to the feature/partner service that will use the resource principal.

In accordance with one or more embodiments, the intermediary accesses link information to determine if there is an active link between the governing tenancy and the subject tenancy. The intermediary also determines if the active tenancy link is for the particular partner service requesting a resource principal. In accordance with one or more embodiments, if there is no active tenancy link between the governing tenancy and the subject tenancy that is associated with the particular partner service, the intermediary denies the invalid request. In accordance with one or more embodiments, if there is an active tenancy link between the governing tenancy and the subject tenancy that is associated with the particular partner service, the intermediary issues a resource principal token that is associated with the subject tenancy (Operation 1250). In accordance with one or more embodiments, once the resource principal token has been issued, the IAM service returns the resource principal token to the intermediary (Operation 1255).

In accordance with one or more embodiments, the intermediary returns the resource principal token to the partner service (Operation 1260). The resource principal token forms the basis for the partner service to authenticate with the subject tenancy. Once the partner service is authenticated with the subject tenancy using the resource principal token, the partner service can interact with resources associated with the subject tenancy. The authorization to interact with resources associated with the subject tenancy is dependent on the locked IAM policies enabled earlier during the handshake process at Operation 1230.

In accordance with one or more embodiments, a resource principal token is valid for a limited duration. After the limited duration, the resource principal token expires. Upon expiration, the partner service using the token can request a new resource principal token from the intermediary. The intermediary will again verify that an active tenancy link exists between the governing tenancy and the subject tenancy, and that the link is associated with the partner service or feature. If the intermediary receives a request that is associated with an expired resource token but a valid active tenancy link exists between the governing tenancy and the subject tenancy, the intermediary may issue a replacement resource principal token that forms the basis for authorization for the governing tenancy to initiate actions associated with the feature within the subject tenancy. The limited duration of validity ensures that the partner service maintains continuous access to necessary without unnecessary security risk.

In accordance with one or more embodiments, a governing tenancy may be linked to multiple subject tenancies, and links may be associated with a variety of services. For example, first a partner service associated with a governing tenancy that performs security operations may be registered as an available feature with the intermediary or an intermediary instance. A second partner service associated with a governing tenancy that performs accounting operations may be registered with the same intermediary as the first partner service. Each of these services may be used to perform operations within many separate subject tenancies in an embodiment. Each tenancy-feature combination will be associated with the governing tenancy in a separate tenancy link in an embodiment since tenancy links include references to the governing tenancy, the subject tenancy, and the feature. This means that each unique combination of governing tenancy, subject tenancy, and feature will be associated with a different tenancy link in an embodiment. In an embodiment, a new resource principal token is generated for each feature/subject tenancy combination since resource principal tokens generated by the intermediary are bound to a subject tenancy.

In accordance with one or more embodiments, a partner service may perform a variety of operations associated with the subject tenancy as long as the operations are consistent with the policies associated with the resource principal being used by the partner service. For example, the partner service may initiate requests to services within the subject tenancy using APIs associated with the subject tenancy services. A partner service may send feature initiation requests that initiate actions associated with partner service features. For example, the partner service may initiate the generation of a report at a subject tenancy service, causing the subject tenancy service to generate the requested report. These requests are made using the principal token provided by the intermediary in response to determining that a link exists between the governing tenancy and the subject tenancy. If the principal token is invalid, then the request will be denied. If the principal token if determined to be valid, then the requested operation is initiated in an embodiment.

In accordance with one or more embodiments, the use of an intermediary to facilitate the creation of links between governing tenancies and subject tenancies and to generate resource principals that are bound to the subject tenancies but used by services associated with governing tenancies enables cross-tenancy interaction with security benefits. By using the methods described herein, actions may be performed by a partner service that has satisfied onboarding criteria and that uses policies that are well-defined and well-understood. For example, the intermediary may be configured to allow only well-understood services to on-board. In addition, the intermediary may be configured to restrict the use of IAM policies that are too permissive. Furthermore, the activity occurring within the tenancy is done using a resource principal from the same tenancy. Rather than forcing tenancy owners to understand IAM policies well enough to ensure that cross-tenancy policies are sufficiently adherent to least-privilege principles, the tenancy owners may instead rely on policies that have been reviewed by the provider of the intermediary. Tenancy owners may subscribe to a specific feature where a trusted third party is providing the policies as long as the tenancy owners agree to them.

In accordance with one or more embodiments, the context determines if a tenancy is a governing tenancy or a subject tenancy. For example, a governing tenancy may exercise control over certain operations with respect to a subject tenancy while being subject to a different governing tenancy for other purposes. To avoid confusion, this additional tenancy will be referred to herein as a supervising tenancy, and a service associated with the managing tenancy will be referred to as a managing service. To illustrate, a managing service that performs accounting operations may be associated with a supervising tenancy in an embodiment. A service that performs security operations may be associated with a governing tenancy. A handshake may occur between the governing tenancy and a subject tenancy to generate a link between the governing tenancy and the subject tenancy that is associated with the security service. A separate handshake may occur between the supervising tenancy and the governing tenancy to generate a link between the supervising tenancy and the governing tenancy that is associated with the accounting service. Although this example appears hierarchical, the example is for illustration purposes, and the relationships are not necessarily hierarchical. For example, a handshake may occur between the governing tenancy and a supervising tenancy to generate a link between the governing tenancy and the supervising tenancy that is associated with the security service. This would ultimately result in a service associated with the governing tenancy performing operations within the supervising tenancy.

### 5. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

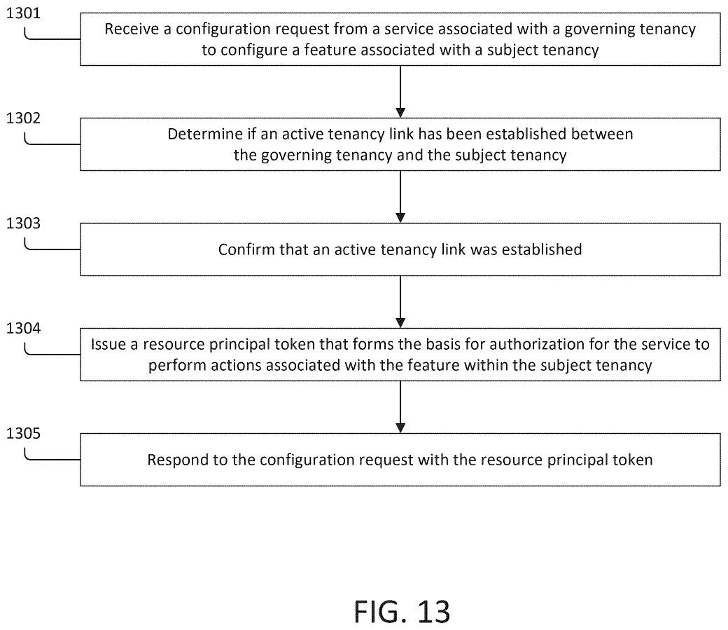

FIG. 13 illustrates an example set of operations for controlling governing tenancy access to subject tenancy resources in accordance with one or more embodiments. One or more operations illustrated in FIG. 13 may be modified, rearranged, or omitted. Accordingly, the particular sequence of operations illustrated in FIG. 13 should not be construed as limiting the scope of one or more embodiments.

In an embodiment, the system receives a configuration request from a service associated with a governing tenancy (Operation 1301). In an embodiment, the configuration request identifies the governing tenancy, a feature, and a subject tenancy. The request may be a request to configure a feature associated with a subject tenancy. For example, in an embodiment, the service may be a security service, and the request to configure a feature may be a request to request to push a system configuration to the subject tenancy, perform an operation within the subject tenancy, or cause an operation to occur within the subject tenancy. In accordance with one or more embodiments, the request to configure a feature may change a configuration within the service, such as a security service or an accounting service. For example, a configuration request may be a request to initiate a rule requiring that a security service perform a security-related scan of the subject tenancy every 12 hours.

In an embodiment, the system determines if an active tenancy link has been established between the governing tenancy and the subject tenancy (Operation 1302). For example, the system accesses link information to determine if there is an active link between the governing tenancy and the subject tenancy. The system also determines if the active tenancy link is for the particular service requesting a resource principal. In an embodiment, an active tenancy link is a stored association between two tenancies. An active tenancy link represents an active agreement authorizing a governing tenancy to initiate operations in a subject tenancy under a set of defined conditions. In accordance with an embodiment, determining if any active tenancy link has been established between a governing tenancy and a subject tenancy includes accessing link mapping data and determining that a mapping between the governing tenancy and the subject tenancy is stored in the link mapping data.

In an embodiment, the system confirms that an active tenancy link was established (Operation 1303). The link, if present, will indicate the governing tenancy, subject tenancy, and service/feature associated with the link. In an embodiment, a link is discovered that identifies the requestor as a service that is associated with the governing tenancy found in the link and verifies that the subject tenancy found in the link is the subject tenancy associated with the request.

In an embodiment, the system issues a resource principal token that forms the basis for authorization for the service to perform actions associated with the feature within the subject tenancy (Operation 1304). If there is an active tenancy link between the governing tenancy and the subject tenancy that is associated with the particular service or feature, the intermediary issues a resource principal that is associated with the subject tenancy. The resource principal is generated at an IAM service in an embodiment. In an embodiment, the system responds to the configuration request with the resource principal token (Operation 1305). Once the resource principal has been issued, the IAM service returns a resource principal token to the system, and the system provides the resource principal token to the requesting service.

In accordance with one or more embodiments, the system identifies a feature from the configuration request and accesses feature configuration information that maps features to configuration operations that are associated with the feature. The system then performs the configuration operations. For example, the configuration operations may include instantiating a policy template associated with the feature.

### 6. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
receiving a configuration request from a first service associated with a governing tenancy to configure a feature associated with a subject tenancy;
determining if any active tenancy link has been established between the governing tenancy and the subject tenancy;
confirming that an active tenancy link has been established between the governing tenancy and the subject tenancy, wherein the active tenancy link was established prior to the receipt of the configuration request;
responsive to the confirming operation:
issuing a resource principal token that forms a basis for authorization for the first service within the governing tenancy to initiate actions, associated with the feature, within the subject tenancy; and
responding to the configuration request with the resource principal token.

2. The computer readable media of claim 1, wherein active tenancy links are stored associations between a plurality of tenancies that represent active agreements authorizing initiation, from one of the tenancies, of operations in another tenancy under a set of defined conditions.

3. The computer readable media of claim 2, wherein determining if any active tenancy link has been established between the governing tenancy and the subject tenancy comprises accessing link mapping data and determining if a mapping between the governing tenancy and the subject tenancy is stored in the link mapping data.

4. The computer readable media of claim 1, further comprising:
identifying the feature from the configuration request;
accessing feature configuration information that maps features to configuration operations to identify first configuration operations associated with the feature; and
performing first configuration operations, wherein the first configuration operations comprise instantiating a policy template.

5. The computer readable media of claim 1, further comprising:
establishing the link at least by:
receiving a link establishment request from a first service associated with the governing tenancy;
in response to the link establishment request, assigning an identity principal to the first service, wherein the identity principal is associated with the subject tenancy; and
registering a policy template associated with the feature.

6. The computer readable media of claim 5, wherein establishing the link further comprises:
generating an invitation to create the active tenancy link between the subject tenancy and the governing tenancy;
sending the invitation to a device corresponding to the subject tenancy;
in response to receiving an acceptance of the invitation, instantiating the policy template;
based on the policy template, generating a link-specific identity and access management policy;
locking the link-specific identity and access management policy; and
storing a mapping between the governing tenancy and the subject tenancy in link mapping data.

7. The computer readable media of claim 6, wherein locking the link-specific identity and access management policy comprises rendering the link-specific identity and access management policy inoperable.

8. The computer readable media of claim 7, further comprising:
accessing triggering event configuration information that identifies triggering events associated with identity and access management policies;
detecting a particular triggering event associated with the link-specific identity and access management policy; and
in response to detecting the particular triggering event, unlocking the link-specific identity and access management policy.

9. The computer readable media of claim 1, further comprising:
receiving a deactivation request to disable the active tenancy link;
in response to the deactivation request, disabling the active tenancy link by one or more of:
a) removing, from link mapping data, a mapping between the governing tenancy and the subject tenancy; or
b) recording a mapping disablement setting.

10. The computer readable media of claim 9, further comprising:
receiving an invalid configuration request from the partner to configure the feature; and
in response to determining that no active tenancy link exists between the governing tenancy and the subject tenancy, denying the invalid configuration request.

11. The computer readable media of claim 1, further comprising:
receiving a request from the first service to perform an operation associated with the subject tenancy, wherein the request is associated with the resource principal token;
determining that the resource principal token is no longer valid; and
responsive to confirming that an active tenancy link exists between the governing tenancy and the subject tenancy, issuing a replacement resource principal token that authorizes the first service within the governing tenancy to initiate actions, associated with the feature, within the subject tenancy.

12. The computer readable media of claim 1, further comprising:
receiving a configuration request from the first service associated with a governing tenancy to configure a second feature associated with a target tenancy that is different from the subject tenancy; and
responsive to determining that an active tenancy link has been established between the governing tenancy and the target tenancy:
issuing a target resource principal token that authorizes the first service within the governing tenancy to initiate actions, associated with the second feature, within the target tenancy.

13. The computer readable media of claim 1, further comprising:
receiving a configuration request from a managing service associated with a supervising tenancy to configure a second feature associated with the governing tenancy; and
in response to determining if any active tenancy link has been established between the supervising tenancy and the governing tenancy:
issuing a resource principal token that authorizes the managing service within the supervising tenancy to initiate actions, associated with the second feature, within the governing tenancy.

14. The computer readable media of claim 1, further comprising:
deploying a rule within the governing tenancy, wherein the rule or task defines a triggering event for the initiation of an operation associated with the subject tenancy; and
in response to an occurrence of the triggering event, the first service sending the configuration request.

15. The computer readable media of claim 1, further comprising:
sending, from the first service to a service associated with the subject tenancy, a feature initiation request to initiate an action associated with the feature; and
wherein the feature initiation request includes the principal token.

16. The computer readable media of claim 1, further comprising:
receiving a feature initiation request from the first service to initiate an action associated with the feature; and
wherein the feature initiation request includes the principal token.

17. The computer readable media of claim 16, further comprising:
in response to determining that the principal token is valid, initiating the action within the subject tenancy.

18. The computer readable media of claim 1, wherein the configuration request identifies:
the governing tenancy;
the feature; and
a subject tenancy.

19. A system comprising:
at least one device including a hardware processor;
the system being configured to perform operations comprising:
receiving a configuration request from a first service associated with a governing tenancy to configure a feature associated with a subject tenancy;
determining if any active tenancy link has been established between the governing tenancy and the subject tenancy;
confirming that an active tenancy link has been established between the governing tenancy and the subject tenancy, wherein the active tenancy link was established prior to the receipt of the configuration request;
responsive to the confirming operation:
issuing a resource principal token that authorizes the first service within the governing tenancy to initiate actions, associated with the feature, within the subject tenancy; and
responding to the configuration request with the resource principal token.

20. A method, comprising:
receiving a configuration request from a first service associated with a governing tenancy to configure a feature associated with a subject tenancy;
determining if any active tenancy link has been established between the governing tenancy and the subject tenancy;
confirming that an active tenancy link has been established between the governing tenancy and the subject tenancy, wherein the active tenancy link was established prior to the receipt of the configuration request;
responsive to the confirming operation:
issuing a resource principal token that authorizes the first service within the governing tenancy to initiate actions, associated with the feature, within the subject tenancy; and
responding to the configuration request with the resource principal token;
wherein the method is performed by at least one device including a hardware processor.
